(19) United States
(12) Patent Application Publication
(10) Pub. No.: US 2008/0190693 A1
(43) Pub. Date: Aug. 14, 2008

(54) Positionable ladder for a sign

(75) Inventors: Robert Douglas Keeler, Memphis, TN (US); Brad Lee Miller, York, PA (US)

Correspondence Address: Russell H. Walker;Walker, McKenzie & Walker, P.C., Suite 434, 6363 Poplar Avenue, Memphis, TN, 38119-4896, US

(73) Assignee: Keeler Iron Works, Inc., Memphis, TN (US)

(21) Appl. No.: 11/706,054

(22) Filed: Feb. 13, 2007

(51) Int. Cl. E06C 9/06

(52) U.S. Cl. 182/115; 182/12

(57) ABSTRACT

A sign with a positionable ladder. The ladder is movable to a plurality of positions in front of a first side sign portion and is movable about a pivot to a position not in front of the first side sign portion to a position behind the first side sign portion. The ladder is mounted to a carriage that moves along the top of the sign on a carriage track, and the ladder pivots about a substantially vertical axis with respect to the carriage. The ladder has inwardly-disposed wheels extending from a lower portion that rest upon a non-horizontal track of the sign.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO COMPACT DISC(S)

Not applicable.

### BACKGROUND OF THE INVENTION

1. Field of the Invention

The present invention relates, in general, to ladders for servicing signs, and in particular, to movable ladders for servicing and working on billboards, outdoor signs and displays, and the like.

2. Information Disclosure Statement

Large signs, billboards, displays, etc., often need to be maintained, painted, serviced, etc., by workers. Well-known solutions for this problem include portable ladders that can be positioned in front of and against the signs. It is particularly hazardous for workers up on an elevated catwalk to use portable ladders that, if not properly secured, could fall and thereby cause the worker to fall and/or be injured. Prior art movable ladders are known that are attached to an outdoor billboard and that hang down in front of the billboard to permit a worker to service the front of the billboard. For example, the advertising company Clear Channel Outdoor Holdings, Inc. (“Clear Channel”), is known to have a prior art ladder that hangs down from an arm atop a sign and moves back and forth in front of the sign as shown in FIGS. 7 and 8 of the drawings, but such a ladder blocks a portion of the sign when the ladder is not in use because the ladder cannot be moved out of view when not in use. Clear Channel is also known to have a variant of this ladder, as shown in FIG. 9, in which the sign has a curved track around one end of the sign so that the ladder can move on the curved track and sit at the end of the sign, out of the way of the front of the sign. Prior art rolling ladders are also known from the nineteenth century that were used in general stores and libraries to access high shelves, and such rolling ladders had, on each of the lower feet of the ladder, rollers that rested on the floor, and had, atop the uppermost legs of the ladder, rollers that rested against a track so that the ladder could roll back and forth in front of shelves, etc. All such known prior art ladders remain in view when not in use, and preclude an unobstructed view, even when the ladder is not in use, of the surface in front of which the ladder moves.

It is therefore desirable to have a movable ladder that can be safely and easily positioned along and in front of a sign by a worker and then easily moved out of view and stored when the ladder is not in use.

### BRIEF SUMMARY OF THE INVENTION

The present invention is a positionable ladder that moves back and forth in front of a sign when the ladder is used to service the sign, and the ladder moves out of the way so that it is not obstructing the view of the sign when not in use and preferably behind the sign. An arm on the upper end of the ladder is attached to a pivot, and the ladder moves about the axis of the pivot as the ladder moves from in front of the sign to a position that is not obstructing the view of the sign.

It is an object of the present invention to provide a positionable ladder that is movable to various positions in front of a sign and that can be moved to a position that is not in front of the sign and preferably out of view behind the sign. It is a further object of the present invention that the ladder be safely attached to the sign, and that it permit a worker to service and maintain various parts of the sign.

### BRIEF DESCRIPTION OF THE SEVERAL VIEWS OF THE DRAWING

FIG. 1 is a top plan view of the present invention showing movement of the ladder into different positions around a sign.

FIG. 2 is a side elevation view of the present invention showing the ladder in front of the sign and also moved into a position that is not obstructing the view of the front of the sign, taken substantially along the line 2-2 shown in FIG. 1.

FIG. 3 is a top plan view of a portion of the present invention, showing movement of the ladder and carriage along the sign.

FIG. 4 is a side sectional view showing the mounting of the carriage to the sign, taken substantially along the line 4-4 shown in FIG. 3.

FIG. 5 is a front elevation view of the present invention showing movement of the ladder in front of the sign and to a position that is not obstructing the view of the front of the sign.

FIG. 6 is a side sectional view showing how the bottom of the ladder rollingly rests against the track of the sign, taken substantially along the line 6-6 shown in FIG. 3.

FIGS. 7 and 8 are front and side elevation views of a prior art ladder used by Clear Channel Outdoor Holdings, Inc., that hangs in front of a sign from an arm atop the sign and moves back and forth in front of the sign but does not move out of view and remains obstructing the view of the front of the sign.

FIG. 9 is a front side elevation of another prior art ladder used by Clear Channel Outdoor Holdings, Inc., in which the ladder may move on a curved track at an end of the sign so as to not obstruct the view of the front of the sign.

### DETAILED DESCRIPTION OF THE INVENTION

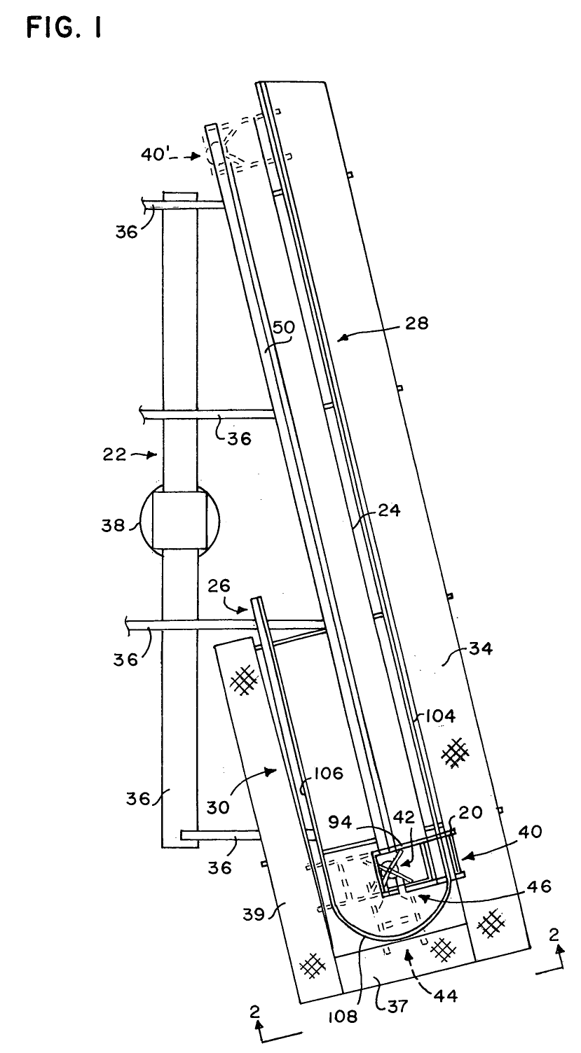

Referring to FIGS. 1-6, the present invention is seen to be a positionable ladder 20 for mounting to a sign 22. Sign 22, except for the improvements and modifications necessary for the present invention, is generally well-known and has many variations with which the positionable ladder 20 of the present invention may be used, and it shall be understood that the term “sign”, as used herein, is to be broadly construed to include billboards, outdoor advertising signs and displays, arena displays, and the like that are large and which require ladders for workers to service and maintain them, as well as the supporting structure for the sign itself. Sign 22 has a primary or first side sign portion 24 and has a secondary or second side sign portion 26, with first side sign portion 24 having an outward-facing or “front” side 28 and with second side sign portion 26 also having an outward-facing or “front” side 30 that, depending on the orientation, might be considered to be at the rear of first side sign portion 24. Sign 22 may have electronic or electric lights that present a message or information on one or both sign portions 24, 26, or may have a canvas or film covering on which text and images 32 are painted or applied on one or both sign portions as seen best in FIG. 5. Though not shown, it is also well-known for sign 22 to have one or more additional sign portions adjacent on either or both ends of first side sign portion 24 and/or second side sign portion 26 so as to present a plurality of informational messages, or to present an elongated single message, as viewed from one side of sign 22. The positionable ladder of the present invention is usable with many, if not all, of these well-known variants of signs, as will be apparent to those skilled in the art once a clear understanding of the present invention is grasped from the disclosure herein.

Sign 22 may have a well-known catwalk 34 so that a worker can walk in front of the sign, and various well-known beams 36 may be provided to support the sign and to mount it to a post 38 that extends to the ground. If desired, an additional catwalk 39 may be provided in front of second sign portion 26 for servicing the rear of the sign, and another catwalk 37 may be provided to join catwalks 34 and 39 so that a worker can move from the first to the second side of sign 22. For structural strength, the supporting structure of sign 22 is typically made of steel or iron. Again, this much is well-known to those skilled in the art.

In the improvement of the present invention, positionable ladder 20 is provided that is movably mounted to sign 22 and that, while remaining movably mounted to sign 22, can move to various positions in front of first side sign portion 24, as shown by position 40 and, in dotted outline, by position 40′. Sign 22 includes a pivot 42, explained in greater detail hereinafter, and, while still remaining mounted to sign 22, ladder 20 is movable about pivot 42 to a first position 44 not in front of first side sign portion 24, with first position 44 preferably being at an end 46 of first side sign portion 24 and with ladder 20 pivoted substantially ninety degrees from its orientation when in front of first side sign portion 24, and ladder 20 is further preferably movable to a storage or second position 48 in front of second side sign portion 26 and behind first side sign portion 26 and out of the view of an observer looking at first side sign portion 24, it being seen that ladder 20 traverses a path from various positions 40, 40′ to position 48 with position 44 being an intermediate position. In one of the simplest preferred embodiments of the present invention as shown in FIG. 1, sign 22 only has a single front face 28 on which images 32 are presented, and ladder 20 moves through first position 44 around end 46 and into second position 48 behind first side sign portion 24 and out of sight for storage when not in use for servicing and maintaining sign 20, thereby not obscuring the view of the front of the first side sign portion 24.

Sign 22 further has an upper portion or top 50 and sign 22 further comprises a carriage 52 movably mounted proximate of top 50 as by carriage 52 being movably mounted to a beam 54, preferably a well-known steel “I-beam” as shown, that extends longitudinally along sign 22 adjacent top 50 of sign 22. In the preferred embodiment, mounted to the underside of the top beam portion 56 of beam 54 as by welding are first and second carriage tracks 58, 60 extending the length of beam 54, with carriage tracks 58 and 60 being substantially similar. Carriage tracks 58, 60 are each a generally rectanular elongated tube having respective downwardly-opening slots 62, 64, with tracks 58, 60 having first and second upwardly-facing inner track surfaces 66, 68 therealong. Carriage 52 preferably wraps around beam 54 with first and second opposed and inwardly-facing flanges 70, 72 from which posts 74, 76 project upwardly and to which carriage wheels 78, 80 are mounted, with carriage wheels 78, 80 supporting carriage 52 by resting upon track surfaces 66, 68 and allowing reciprocating movement of carriage 52 along carriage tracks 58, 60.

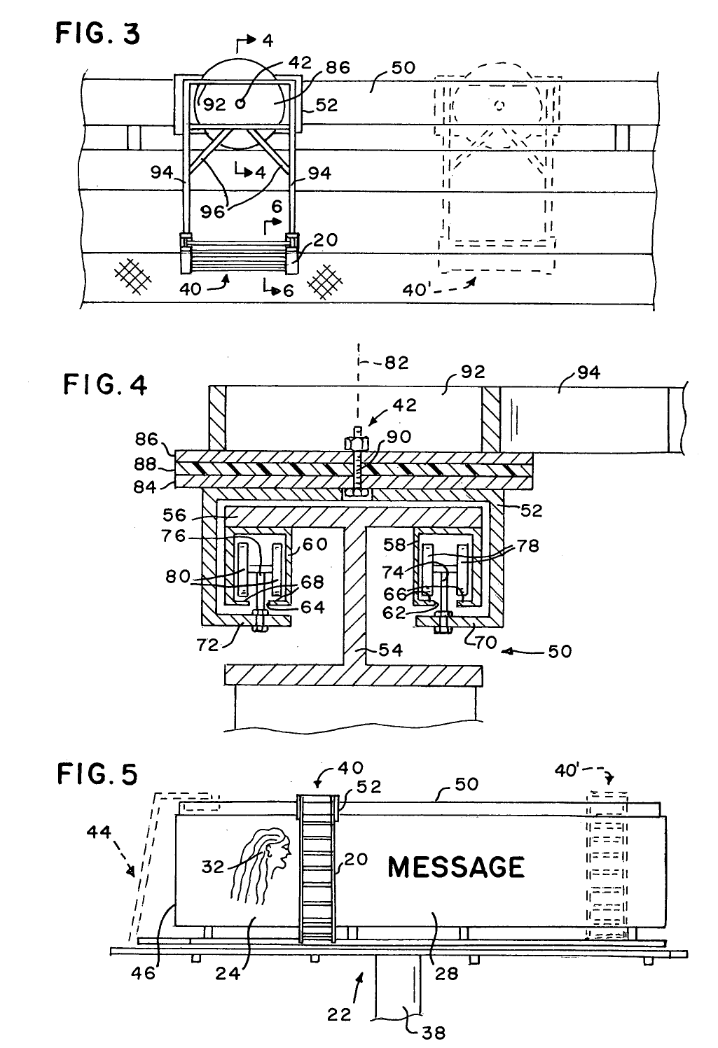

As best seen in FIG. 4, pivot 42 has a substantially vertical axis 82 about which ladder 20 rotates, and pivot 42 preferably comprises a first substantially circular bearing plate 84 mounted to carriage 52, a second substantially circular bearing plate 86, a substantially circular low-friction plate 88 (preferably of well-known ultra-high molecular weight (“UHMW”) polyethylene plastic) sandwiched between first and second plates 84 and 86, and an axle 90, such as a 1.5 inch (3.81 cm.) bolt, mounting second bearing plate 86 to first bearing plate 84 for rotation of second bearing plate 86 with respect to first bearing plate 84 about axis 82, with ladder 20 being mounted to second bearing plate 86, as by a frame 92 including arms 94 and struts 96 best seen in FIG. 3, for mutual pivoting movement of ladder 20 with second bearing plate 86.

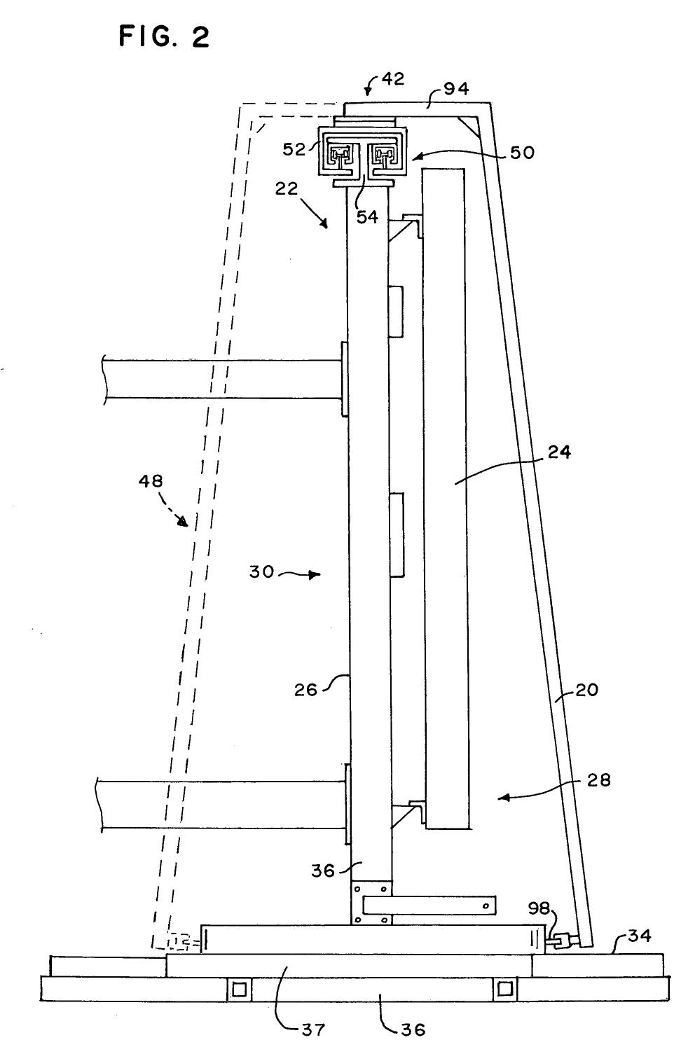

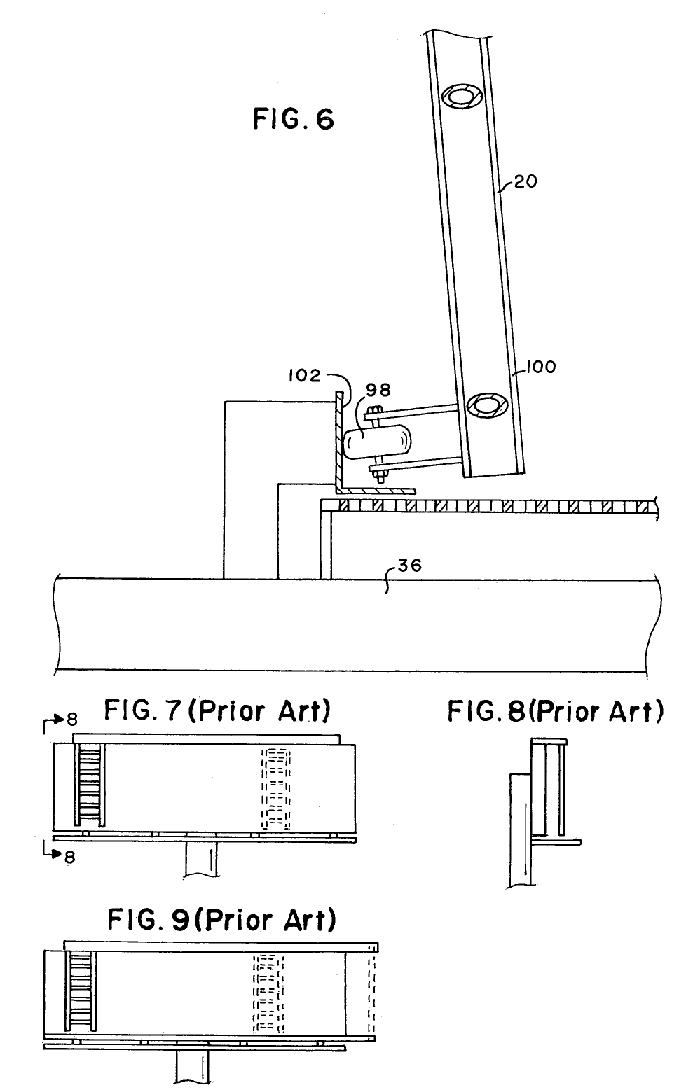

As best seen in FIG. 2 and 6, ladder 20 preferably includes an inwardly-disposed wheel 98 extending from a lower portion 100 of ladder 20, preferably with one such wheel 98 being mounted to each leg of ladder 20 in a somewhat generally horizontal orientation, with wheel 98 resting upon and moving along a non-horizontal and preferably vertical portion of sign 22 as upon a track 102 that may be formed of an L-shaped piece of iron or steel for rigidity. As best seen in FIG. 1, track 102 has first and second substantially straight portions 104, 106 that are respectively mounted to lower portions of first and second sign portions 24, 26 with track 102 having a curved track portion 108 joining track portions 104, 106 around end 46 so that ladder 20 can pivot about axis 82 as it moves from position 40 to position 44 to position 48. An advantage of having wheel 98 moving along a non-horizontal and preferably vertical portion of sign 22 upon track 102 rather than having wheel 98 extend downwardly upon a horizontal surface is the greater simplicity with which curved track portion 108 can be formed using the structure of the present invention's non-horizontal track.

To use the present invention, carriage 52 is moved along sign 22 to various positions as a worker climbs up and down ladder 20 to service and maintain sign 22. When the maintenance is completed, carriage 52 is moved to end 46 and ladder 20 is pivoted about axis 82 while still mounted to sign 22, and then preferably around behind sign 22 and out of view.

Although the present invention has been described and illustrated with respect to a preferred embodiment and a preferred use therefor, it is not to be so limited since modifications and changes can be made therein which are within the full intended scope of the invention.

We claim:

1. A sign with a positionable ladder, said sign having a first side sign portion and having a pivot, said ladder being movably mounted to said sign and, while remaining mounted to said sign, said ladder being movable to a plurality of positions in front of said first side sign portion and also being movable about said pivot to a first position not in front of said first side sign portion.

2. The sign with positionable ladder as recited in claim 1, said ladder having a lower portion thereof and said ladder comprising an inwardly-disposed wheel extending from said lower portion of said ladder and that rests upon and moves along a non-horizontal portion of said sign.

3. The sign with positionable ladder as recited in claim 1, said sign further having a second side sign portion and said ladder further being movable to a second position in front of said second side sign portion.

4. The sign with positionable ladder as recited in claim 1, said sign further having a top and said sign comprising a carriage movably mounted proximate said top of said sign for reciprocating movement with respect thereto, said ladder being mounted to said carriage.

5. The sign with positionable ladder as recited in claim 4, said pivot being mounted to said carriage.

6. The sign with positionable ladder as recited in claim 5, said ladder having a lower portion thereof and said ladder comprising an inwardly-disposed wheel extending from said lower portion of said ladder and that rests upon and moves along a non-horizontal portion of said sign.

7. The sign with positionable ladder as recited in claim 4, said sign further comprising a carriage track adjacent said top of said sign, said carriage having a carriage wheel in engagement with said carriage track for allowing said reciprocating movement of said carriage.

8. The sign with positionable ladder as recited in claim 4, said sign further comprising:
(a) a beam extending longitudinally adjacent said top of said sign; and
(b) a carriage track mounted to said beam and extending therealong, said carriage track having first and second track surfaces therealong;
said carriage having first and second carriage wheels respectively supporting said carriage upon said first and second track surfaces for allowing said reciprocating movement of said carriage along said carriage track.

9. The sign with positionable ladder as recited in claim 8, said pivot having a substantially vertical axis and said pivot comprising:
(a) a first bearing plate mounted to said carriage;
(b) a second bearing plate; and
(c) an axle mounting said second bearing plate to said first bearing plate for rotation of said second bearing plate with respect to said first bearing plate about said axis;
said ladder being mounted to said second bearing plate for mutual movement therewith.

10. The sign with positionable ladder as recited in claim 9, said ladder having a lower portion thereof and said ladder comprising an inwardly-disposed wheel extending from said lower portion of said ladder and that rests upon and moves along a non-horizontal portion of said sign.

11. The sign with positionable ladder as recited in claim 9, said pivot further comprising a low-friction plate sandwiched between said first and second bearing plates.
